(19) United States
(12) Patent Application Publication
(10) Pub. No.: US 2026/0031621 A1
(43) Pub. Date: Jan. 29, 2026

(54) MODULATING POWER CONSUMPTION OF AN ELECTRONIC DEVICE POWERED BY HARVESTED ENERGY

(71) Applicant: Roku, Inc., San Jose, CA (US)

(72) Inventors: Frank Llewellyn MAKER, III, Livermore, CA (US); Gregory Mack Garner, Key Colony Beach, FL (US)

(73) Assignee: Roku, Inc., San Jose, CA (US)

(21) Appl. No.: 18/783,771

(22) Filed: Jul. 25, 2024

(51) Int. Cl. H02J 3/00; H02J 50/00; H02J 50/10

(52) U.S. Cl. CPC H02J 3/004; H02J 3/003; H02J 50/001; H02J 50/10; H02J 2300/24

(57) ABSTRACT

Disclosed herein are system, method and/or computer program product embodiments, and/or combinations and sub-combinations thereof, for modulating power consumption of a device powered by harvested energy. An example embodiment operates by executing a model, such as a machine learning model, that predicts an amount of energy that will be harvested over a future time period by an energy harvesting component used to power an electronic device, determining an energy budget for the electronic device based at least on the predicted amount of energy that will be harvested, determining, based on the energy budget, that an amount of energy available for powering the electronic device is below a predetermined threshold, and modulating power consumption by the electronic device based on the determination that the amount of energy available for powering the electronic device is below the predetermined threshold.

### BACKGROUND

### FIELD

This disclosure is generally directed to techniques for facilitating continued operation of an electronic device that is powered by at least one energy harvesting component.

### SUMMARY

Provided herein are system, apparatus, article of manufacture, method and/or computer program product embodiments, and/or combinations and sub-combinations thereof, for modulating power consumption of an electronic device powered by harvested energy. An example embodiment performs operations including executing a model that predicts an amount of energy that will be harvested over a future time period by an energy harvesting component used to power an electronic device, determining an energy budget for the electronic device based at least on the predicted amount of energy that will be harvested, determining, based on the energy budget, that an amount of energy available for powering the electronic device is below a predetermined threshold, and modulating power consumption by the electronic device based on the determination that the amount of energy available for powering the electronic device is below the predetermined threshold.

In some aspects, the energy harvesting component comprises one or more photovoltaic cells.

In some aspects, the energy harvesting component comprises an inductive charging component.

In some aspects, the electronic device is one of a remote control device or an Internet of Things (IoT) device.

In some aspects, executing the model comprises executing a machine learning model.

In some aspects, the energy budget for the electronic device is determined based at least on the predicted amount of energy that will be harvested and an amount of energy currently stored by one or more energy storage devices of the electronic device. Additionally, the operations may further comprise predicting an amount of energy that will be consumed by the electronic device over the future time period, and the energy budget for the electronic device may be determined based at least on the predicted amount of energy that will be harvested, the predicted amount of energy that will be consumed, and an amount of energy currently stored by the one or more energy storage devices of the electronic device

In some aspects, modulating the power consumption by the electronic device comprises switching the electronic device from operating in a first power consumption mode to operating in a second power consumption mode, wherein the operating in the second power consumption mode consumes less power than operating in the first power consumption mode.

In some aspects, modulating the power consumption by the electronic device comprises one or more of disabling a feature of the electronic device, reducing a quality of a service performed by the electronic device, increasing a delay between operations performed by the electronic device, or reducing one or more of a frequency of a processing circuit of the electronic device or a voltage of the processing circuit of the electronic device.

### BRIEF DESCRIPTION OF THE FIGURES

The accompanying drawings are incorporated herein and form a part of the specification.

FIG. 1 illustrates a block diagram of a multimedia environment that includes a remote control powered by an energy harvesting component and that includes a power consumption manager that modulates power consumption thereby, according to some embodiments.

FIG. 2 illustrates a block diagram of a streaming media device, according to some embodiments.

FIG. 3 illustrates a block diagram of the power consumption manager of the remote control of FIG. 1, according to some embodiments.

FIG. 4 illustrates a flow diagram of a method for modulating power consumption of an electronic device powered, at least in part, by harvested energy, according to some embodiments.

FIG. 5 illustrates a block diagram of a system of Internet of Things (IoT) devices in which at least one IoT device in the system is powered by an energy harvesting component and in which a power consumption manager modulates power consumption by the at least one IoT device, according to some embodiments.

FIG. 6 illustrates a block diagram of a system in which a plurality of electronic devices in a premises are powered by the same energy harvesting component and in which a premises power consumption manager modulates power consumption by the plurality of electronic devices, according to some embodiments.

FIG. 7 illustrates a flow diagram of a method for modulating power consumption of one or more electronic devices powered, at least in part, by the same energy harvesting component, according to some embodiments.

FIG. 8 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Some electronic devices are designed to be untethered from a wall power supply. For example, some consumer electronic devices, such as some media player remote controls and some smart security cameras, may be configured to run exclusively off of one or more rechargeable or non-rechargeable batteries. A drawback associated with such devices is the possibility that the battery or batteries will run out of energy prior to recharging or replacement, in which case the device will become non-operational. Another drawback associated with such devices is the increased cost and form factor associated with housing the one or more batteries.

Some electronic devices utilize an energy harvesting component to harvest energy from the environment. For example, some electronic devices incorporate or may be connected to a solar panel that is used to convert ambient light into energy for powering the device. As another example, some electronic devices incorporate a wireless charger that includes an induction coil that, when placed in proximity and parallel to another induction coil (e.g., in a wireless charging pad), transfers energy via induction to the wireless charger. Such electronic devices may further incorporate a rechargeable battery for storing harvested energy.

A significant challenge associated with electronic devices that rely on harvested energy is that the times and circumstances during which energy may be harvested may be varied and unpredictable. For example, a smart security camera that utilizes a solar panel to recharge an internal battery may be incapable of recharging when interior lighting is turned off (if located inside a premises) or when sunlight is absent due to cloudy weather (if located outside a premises). As another example, a remote control that incorporates a wireless charger may be incapable of recharging an internal battery if a user frequently forgets to place it on top of a wireless charging pad. If conditions for harvesting energy remain poor over a prolonged period, such devices may run out of power and become entirely non-operational.

Provided herein are system, method and/or computer program product embodiments, and/or combinations and sub-combinations thereof, for modulating energy consumption of an electronic device powered by harvested energy that addresses one or more of the foregoing issues associated with conventional electronic devices that are powered by harvested energy. As will be discussed in more detail herein, an electronic device may include a power consumption manager that predicts an amount of energy that will be harvested over a future time period by an energy harvesting component used to power the electronic device, determines an energy budget for the electronic device based at least on the predicted amount of energy that will be harvested, determines, based on the energy budget, that an amount of energy available for powering the electronic device is below a predetermined threshold, and modulates power consumption by the electronic device based at least on the determination that the amount of energy available for powering the electronic device is below the predetermined threshold. In some aspects, the energy budget for the electronic device may be determined based on the predicted amount of energy that will be harvested as well as an amount of energy currently stored by one or more energy storage devices of the electronic device. In further aspects, the energy budget for the electronic device may be determined in a manner that also takes into account a predicted amount of energy that will be consumed by the electronic device over the future time period.

Since the power consumption manager is capable of predicting the amount of energy that the electronic device will be able to harvest over the future time period, the power consumption manager can determine an energy budget for the device that takes into account future times during which harvesting energy will not be possible. If such energy budget indicates that there will be insufficient energy to maintain full power operation of the electronic device until recharging is possible, then the power consumption manager can modulate (e.g., reduce) power consumption by the electronic device to prolong the time during which the electronic device remains operational. As will be discussed herein, such modulation of power consumption by the electronic device may include, for example, switching the electronic device from operating in a first power consumption mode to operating in a second power consumption mode, wherein operating in the second power consumption mode consumes less power than operating in the first power consumption mode. As other examples, such modulation of power consumption by the electronic device may include disabling a feature of the electronic device, reducing a quality of a service provided by the electronic device, increasing a delay between operations performed by the electronic device, or reducing one or more of a frequency of a processing circuit of the electronic device or a voltage of the processing circuit of the electronic device.

Accordingly, example implementations described herein facilitate continued operation of electronic devices that are powered by harvested energy even when the ability to harvest energy becomes limited. Example implementations described herein can also intelligently allocate a limited energy budget to features and operations that are deemed most essential or important to a user or a premises, or reduce a quality of a service provided by the electronic device within acceptable limits, thereby allowing the electronic device to adapt gracefully to changing power conditions. Furthermore, example implementations described herein can help reduce the cost of the electronic device by allowing for the use of a smaller battery.

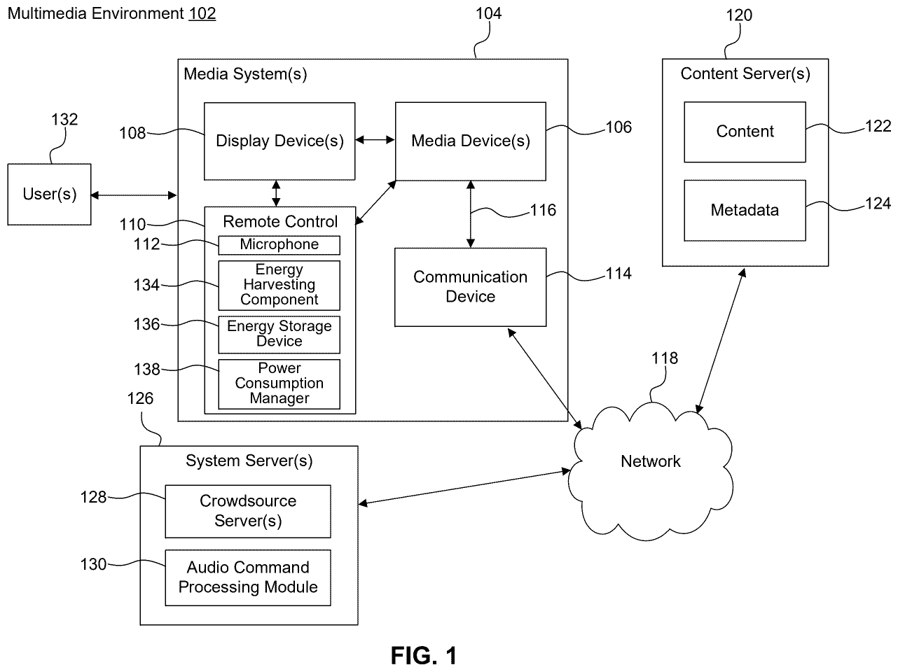

These and various other features and advantages of a system, method and/or computer program product, and/or combinations and sub-combinations thereof, for modulating energy consumption of an electronic device powered by harvested energy will be described in detail herein in reference to various embodiments. Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

Multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. Communication device 114 may include, for example, a cable modem or satellite TV transceiver. Media device 106 may communicate with communication device 114 over a link 116, wherein link 116 may include wireless (such as Wi-Fi) and/or wired connections.

In various embodiments, network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. Remote control 110 can be any component, part, apparatus and/or method for controlling media device 106 and/or display device 108, such as a remote control, a tablet, laptop computer, smartphone, wearable, on-screen controls, integrated control buttons, audio controls, or any combination thereof, to name just a few examples. In an embodiment, remote control 110 wirelessly communicates with media device 106 and/or display device 108 using cellular, Bluetooth, infrared, etc., or any combination thereof. Remote control 110 may include a microphone 112, an energy harvesting component 134, an energy storage device 136, and a power consumption manager 138, each of which is further described below.

Multimedia environment 102 may include a plurality of content servers 120 (also called content providers, channels or sources 120). Although only one content server 120 is shown in FIG. 1, in practice multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form. In some embodiments, content server(s) 120 may include a live streaming content origin server and content 122 may comprise live streaming content.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to content 122. Metadata 124 may also or alternatively include one or more indexes of content 122, such as but not limited to a trick mode index.

Multimedia environment 102 may include one or more system servers 126. System servers 126 may operate to support media devices 106 from the cloud. It is noted that the structural and functional aspects of system servers 126 may wholly or partially exist in the same or different ones of system servers 126.

Media devices 106 may exist in thousands or millions of media systems 104. Accordingly, media devices 106 may lend themselves to crowdsourcing embodiments and, thus, system servers 126 may include one or more crowdsource servers 128.

For example, using information received from media devices 106 in the thousands and millions of media systems 104, crowdsource server(s) 128 may identify similarities and overlaps between closed captioning requests issued by different users 132 watching a particular movie. Based on such information, crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, crowdsource server(s) 128 may operate to cause closed captioning to be automatically turned on and/or off during future streamings of the movie.

System servers 126 may also include an audio command processing module 130. As noted above, remote control 110 may include microphone 112. Microphone 112 may receive audio data from users 132 (as well as other sources, such as the display device 108). In some embodiments, media device 106 may be audio responsive, and the audio data may represent verbal commands from user 132 to control media device 106 as well as other components in media system 104, such as display device 108.

In some embodiments, the audio data received by microphone 112 in remote control 110 is transferred to media device 106, which is then forwarded to audio command processing module 130 in system servers 126. Audio command processing module 130 may operate to process and analyze the received audio data to recognize user 132′s verbal command. Audio command processing module 130 may then forward the verbal command back to media device 106 for processing.

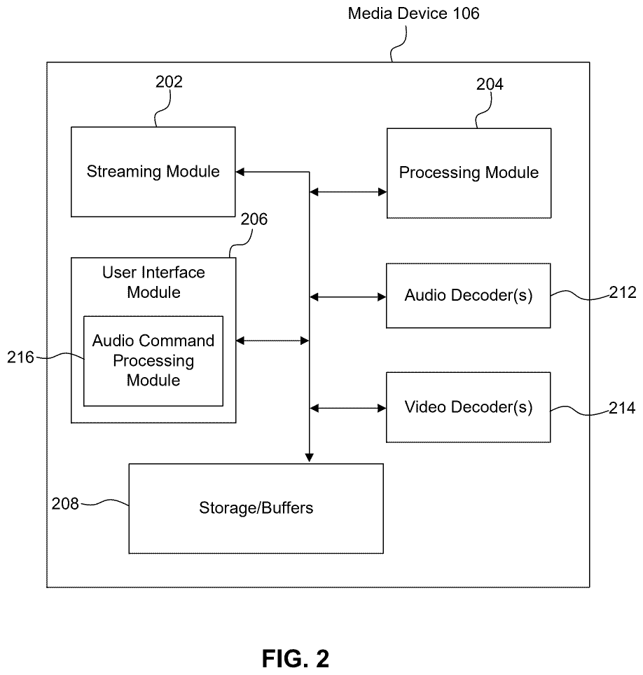

In some embodiments, the audio data may be alternatively or additionally processed and analyzed by an audio command processing module 216 in media device 106 (see FIG. 2). Media device 106 and system servers 126 may then cooperate to pick one of the verbal commands to process (either the verbal command recognized by audio command processing module 130 in system servers 126, or the verbal command recognized by audio command processing module 216 in media device 106).

FIG. 2 illustrates a block diagram of an example media device 106, according to some embodiments. Media device 106 may include a streaming module 202, a processing module 204, storage/buffers 208, and a user interface module 206. As described above, user interface module 206 may include audio command processing module 216.

Media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, user 132 may interact with media device 106 via, for example, remote control 110. For example, user 132 may use remote control 110 to interact with user interface module 206 of media device 106 to select content, such as a movie, TV show, music, book, application, game, etc. Streaming module 202 of media device 106 may request the selected content from content server(s) 120 over network 118. Content server(s) 120 may transmit the requested content to streaming module 202. Media device 106 may transmit the received content to display device 108 for playback to user 132.

In streaming embodiments, streaming module 202 may transmit the content to display device 108 in real time or near real time as it receives such content from content server(s) 120. In non-streaming embodiments, media device 106 may store the content received from content server(s) 120 in storage/buffers 208 for later playback on display device 108.

### Modulating Energy Consumption of an Electronic Device Powered by Harvested Energy

As noted above, remote control 110 may include energy harvesting component 134, energy storage device 136 and power consumption manager 138. Energy harvesting component 134 may comprise a component that harvests energy from an environment of remote control 110 for the purposes of powering remote control 110. Energy harvesting component 134 may comprise, for example, a solar panel comprising one or more photovoltaic cells that convert ambient light in the environment of remote control 110 into energy. Energy harvesting component 134 may alternatively comprise, for example, a wireless charger that includes an induction coil that, when placed in proximity and parallel to another induction coil (e.g., in a wireless charging pad), transfers energy via induction to the wireless charger. However, these examples are not intended to be limiting and energy harvesting component 134 may comprise any component capable of harvesting energy from any energy source in the environment of remote control 110, wherein the energy source may include, for example and without limitation, a light source, an electromagnetic field generator, a kinetic energy source (e.g., wind, ambient vibrations, motion of remote control 110, or keypresses applied to remote control 110), a thermal energy source (e.g., a temperature gradient), a generator of radio waves, or the like.

Energy harvesting component 134 may be integrated with remote control 110 (e.g., integrated into a housing of remote control 110) or may be separate from but connectable to remote control 110 via a physical interface or connector that is suitable for transferring harvested energy from energy harvesting component 134 to remote control 110.

Energy storage device 136 may comprise, for example, a non-rechargeable battery, a rechargeable battery, or a supercapacitor that stores energy for use in powering remote control 110. Energy storage device 136 may be housed internally within remote control 110. Alternatively, energy storage device 136 may be external to remote control 110 and connected thereto via a suitable physical interface or connector. Although only a single energy storage device 136 is shown in FIG. 1, it should be understood that remote control device 110 may include multiple energy storage devices.

Example non-rechargeable battery types that may be used to power remote control 110 include but are not limited to alkaline batteries, lithium batteries, mercury batteries, silver oxide batteries or zinc air batteries. Example re-chargeable battery types that may be used to power remote control 110 include but are not limited to lithium-ion batteries, nickel-cadmium batteries, nickel metal hydride batteries, and lead acid gel batteries. In a case in which energy storage device 136 comprises a rechargeable battery or a supercapacitor, remote control 110 may be configured to recharge energy storage device 136 using energy provided by energy harvesting component 134.

Power consumption manager 138 comprises a component of remote control 110 that operates at least in part to periodically or intermittently determine an energy budget for remote control 110 and, when the energy budget indicates that there is insufficient energy to maintain a certain degree of operation of remote control 110 for a desired time period, to modulate (e.g., reduce) power consumption by remote control 110 to prolong the operation thereof. Power consumption manager 138 may be implemented using processing logic that can comprise hardware (e.g., circuitry, dedicated logic, programmable logic, microcode, etc.), software (e.g., instructions executing on a processing device), or a combination thereof.

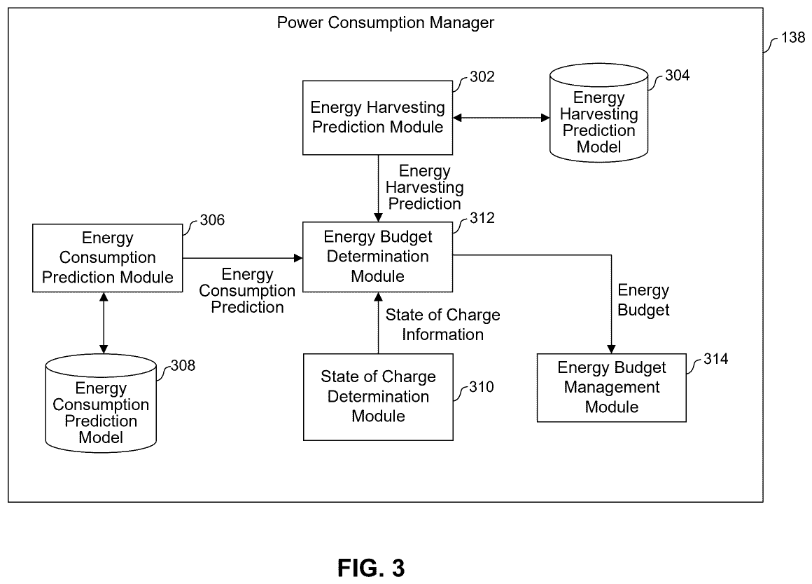

FIG. 3 illustrates a block diagram of power consumption manager 138, according to some example embodiments. As shown in FIG. 3, power consumption manager 138 includes an energy harvesting prediction module 302, an energy harvesting prediction model 304, an energy consumption prediction module 306, an energy consumption prediction model 308, a state of charge determination module 310, an energy budget determination module 312, and an energy budget management module 314. Each of these components will now be described.

Energy harvesting prediction module 302 is configured to predict an amount of energy that will be harvested over a future time period by energy harvesting component 134. To perform this function, energy harvesting prediction module 302 may utilize energy harvesting prediction model 304. Energy harvesting prediction model 304 may comprise a model that is configured to predict an amount of energy that will be harvested by energy harvesting component 134 over a future time period. Energy harvesting prediction model 304 may comprise, for example, a fixed analytical model or a machine learning model. Energy harvesting prediction module 302 is further configured to provide the energy harvesting prediction to energy budget determination module 312, or store the energy harvesting prediction in a memory location accessible to energy budget determination module 312. Energy harvesting prediction module 302 may be configured to generate a new or updated energy harvesting prediction automatically (e.g., periodically or at predetermined times) and/or in response to receiving a request for same from energy budget determination module 312 or some other event.

In certain implementations in which energy harvesting prediction model 304 comprises a machine learning model, power consumption manager 138 may be configured to collect data that may be used to train energy harvesting prediction model 304. For example, power consumption manager 138 may be configured to collect data regarding times when energy is harvested by energy harvesting component 134, amounts of energy harvested by energy harvesting component at different times, or any other historical data that may be useful in generating an energy harvesting prediction. The training of the machine learning model may be carried out in real-time or in an offline mode.

In certain implementations in which energy harvesting component 134 comprises one or more outdoor solar panels, energy harvesting prediction model 304 may be based on or take into account weather forecast information for the geographic area in which the solar panel(s) are located. Energy harvesting prediction model 304 may also be based on or take into account solar insolation predictions for the geographic area in which the solar panel(s) are located. Such solar insolation predictions may be obtained, for example, from a third-party service or online resource. Energy harvesting prediction model 304 could also be a fixed analytical model that takes into account the insolation at a particular latitude and longitude at a particular date and time of day. In a further implementation, a fixed loss due to atmospheric conditions could be used or even learned over time. In such a scenario, there may be no need to communicate with a third-party service and no need for an internet connection.

In certain implementations, energy harvesting prediction model 304 may take into account a decreased capacity of energy storage device 136 over time. For example, certain rechargeable batteries may lose capacity over time. Energy harvesting prediction model 304 may take such decreased capacity into account when predicting an amount of energy that will be harvested over a future time period by energy harvesting component 134.

Energy consumption prediction module 306 is configured to predict an amount of energy that will be consumed over a future time period by remote control 110. To perform this function, energy consumption prediction module 306 may utilize an energy consumption prediction model 308. Energy consumption prediction model 308 may comprise a model that is configured to predict an amount of energy that will be consumed by remote control 110 over a future time period. Energy consumption prediction model 308 may comprise, for example, a fixed analytical model or a machine learning model. Energy consumption prediction module 306 is further configured to provide the energy consumption prediction to energy budget determination module 312, or store the energy consumption prediction in a memory location accessible to energy budget determination module 312. Energy consumption prediction module 306 may be configured to generate a new or updated energy consumption prediction automatically (e.g., periodically or at predetermined times) and/or in response to receiving a request for same from energy budget determination module 312 or some other event.

In certain implementations in which energy consumption prediction model 308 comprises a machine learning model, power consumption manager 138 may be configured to collect data that may be used to train energy consumption prediction model 304. For example, power consumption manager 138 may be configured to collect data regarding when features of remote control 110 have been activated that consume power, how much power those features consumed, or any other historical data that may be useful in generating an energy consumption prediction. The training of the machine learning model may be carried out in real-time or in an offline mode.

State of charge determination module 310 is configured to determine how much energy remains in energy storage device 136 (or in multiple energy storage devices if remote control 110 comprises multiple energy storage devices) and to provide such state of charge information to energy budget determination module 312, or store the state of charge information in a memory location accessible to energy budget determination module 312. State of charge determination module 310 may be configured to generate new or updated state of charge information automatically (e.g., periodically or at predetermined times) and/or in response to receiving a request for same from energy budget determination module 312 or some other event.

Energy budget determination module 312 is configured to periodically or intermittently determine an energy budget for remote control 110. The energy budget may represent an amount of energy available for powering remote control 110 over a predetermined future time period. Energy budget determination module 312 may determine an energy budget based on state of charge information obtained from state of charge determination module 310, an energy harvesting prediction obtained from energy harvesting prediction module 302, and an energy consumption prediction obtained from energy consumption prediction module 306. An energy budget for a particular future time period may be represented as a measurement of available energy that varies over the future time period. Such variation may represent, for example, the addition of energy to the energy budget at times when energy harvesting is predicted to occur and the removal of energy from the energy budget when energy consumption is predicted to occur. Energy budget determination module 312 is further configured to provide the energy budget to energy budget management module 314, or store the energy budget in a memory location accessible to budget management module 314. Energy budget determination module 312 may be configured to generate a new or updated energy budget automatically (e.g., periodically or at predetermined times) and/or in response to receiving a request for same from energy budget determination module 312 or some other event.

Energy budget management module 314 is configured to periodically or intermittently obtain an energy budget from energy budget determination module 312 and to utilize such energy budget to manage power consumption by remote control 110. In particular, energy budget management module 314 may determine, based on an energy budget received from energy budget determination module 312, that at some future point in time the energy available for powering remote control 110 will drop below a threshold level required to maintain a particular mode or level of operation of remote control 110 or that at some future point in time no energy will be available for powering remote control 110. In response to making such a determination, energy budget management module may reduce power consumption by remote control 110 to prolong a time during which remote control 110 remains at a certain mode or level of operation or to prolong a time during which remote control 110 is operational at all.

For example, to reduce power consumption by remote control 110, energy budget management module 314 may disable a particular feature of remote control 110, reduce a quality of a service provided by remote control 110, increase a delay between operations performed by remote control 110, or reduce one or more of a frequency of a processing circuit (e.g., a CPU, microprocessor, or system-on-chip (SOC)) of remote control 110 or a voltage of the processing circuit of remote control 110.

In certain implementations, remote control 110 may be capable of operating in different power consumption modes. For example, remote control 110 may be capable of operating in at least a first power consumption mode and a second power consumption mode, wherein operating in the second power consumption mode consumes less power than operating in the first power consumption mode. In accordance with such implementations, energy budget management module 314 may reduce power consumption by remote control 110 by switching remote control 110 from operating in the first power consumption mode to operating in the second power consumption mode.

Some further non-limiting examples of methods by which energy budget management module 314 may reduce power consumption by remote control 110 include: temporarily disabling automatic software updates, temporarily disabling a “wake on sound” feature of remote control 110, reducing a frequency with which remote control 110 wakes from a low-power state to perform an operation, reducing a power of an RF signal transmitted by remote control 110, reducing a transmission data rate of remote control 110, or reducing a power of an IR signal transmitted by remote control 110. With respect to disabling a particular feature of remote control 110, power consumption manager 138 may be configured to learn over time which features of remote control 110 a user tends to use and which features of remote control 110 a user tends not to use. Then, based on such information, power consumption manager 138 can prioritize disabling features that the user tends not to use before disabling features that the user tends to use.

In some implementations, energy budget management module 314 may be configured to initiate operations that may result in increased energy harvesting by energy harvesting component 134 based on the energy budget generated by energy budget determination module 312 and/or the energy harvesting prediction generated by energy harvesting prediction module 302. For example, in certain implementations in which energy harvesting component 134 comprises a solar panel, energy budget management module 314 may be configured to drive an actuator (e.g., a motor) that may adjust a position or orientation of the solar panel so as to increase the amount of solar energy harvested thereby. As another example, in certain implementations in which energy harvesting component 134 comprises a wireless charger, energy budget management module 314 may be configured to generate a user-perceptible alert that reminds a user to place remote control 110 on a wireless charging pad. Energy budget management module 314 may trigger still other operations that may result in increased energy harvesting by energy harvesting component 134.

Energy budget management module 314 may also determine, based on an energy budget obtained from energy budget determination module, 312 that at some future point in time the energy available for powering remote control 110 will be above a threshold level required to support a particular mode or level of operation of remote control 110. In response to making such a determination, energy budget management module 312 may increase power consumption by remote control 110. For example, to increase power consumption by remote control 110, energy budget management module 314 may enable a previously disabled feature of remote control 110, increase a quality of a service provided by remote control 110, reduce a delay between operations performed by remote control 110, or increase one or more of a frequency of a processing circuit of remote control 110 or a voltage of the processing circuit of remote control 110.

Furthermore, in implementations in which remote control 110 is capable of operating in different power consumption modes, energy budget management module 314 may increase power consumption by remote control 110 by switching remote control 110 from operating in a second power consumption mode to operating in a first power consumption mode, wherein operating in the second power consumption mode consumes less power than operating in the first power consumption mode.

In an alternate implementation to that shown in FIG. 3, power consumption manager 138 may not include energy consumption prediction module 306. In accordance with such an implementation, energy budget determination module 312 may determine the energy budget based solely on the state of charge information obtained from battery status determination module 310 and the energy harvesting prediction obtained from energy harvesting prediction module 302. In another alternate implementation, power consumption manager 138 may not include energy consumption prediction module 306 or state of charge determination module 310. In accordance with such an implementation, energy budget determination module 312 may determine the energy budget based solely on the energy harvesting prediction obtained from energy harvesting prediction module 302.

Furthermore, although power consumption manager 138 is shown as being part of remote control 110 in FIG. 1, in an alternate implementation, power consumption manager 138 may be part of a device that is external to remote control 110 but communicatively connected thereto (e.g., media device 106). For example, the external device may collect information from remote control 110 necessary to generate an energy budget therefor (e.g., state of charge information, information used as inputs to energy harvesting prediction model 304 and/or energy consumption prediction model 308, and/or information used to train such models) and then provide commands to remote control 110 for modulating power consumption thereby if the external device determines that such modulation is needed. In a still further implementation, the features of power consumption manager 138 may be distributed between remote control 110 and one or more external devices that are communicatively connected thereto. As one example of this, power consumption manager 138 may be part of remote control 110 but may place a call to a remote server (e.g., via media device 106) to obtain the energy harvesting prediction or the energy consumption prediction. However, this is only an example, and a variety of other distributed processing configurations are possible.

Although the foregoing refers to determining an energy budget based on an energy harvesting prediction generated by energy harvesting prediction model 304 and an energy consumption prediction generated by energy consumption prediction model 308 and then making power consumption management decisions based on the energy budget, in an alternate embodiment, a single model may be used that accepts as inputs the various inputs provided to energy harvesting prediction model 304 and energy consumption prediction model 308 and that outputs a set of power consumption management decisions. Such power consumption management decisions may include, for example, switching remote control 110 to a different power consumption mode at a particular time or implementing some other actions that will modulate power consumption of remote control 110. The single model may comprise, for example, a fixed analytical model or a machine learning model. In an implementation in which the single model comprises a machine learning model, the model may be trained to optimize for efficiency or for extending the life of energy storage device 136. Various machine learning techniques may be used to implement any of the models described herein including, but not limited to, Markov Decision Process, Bayesian Networks, and RNN-type deep learning model.

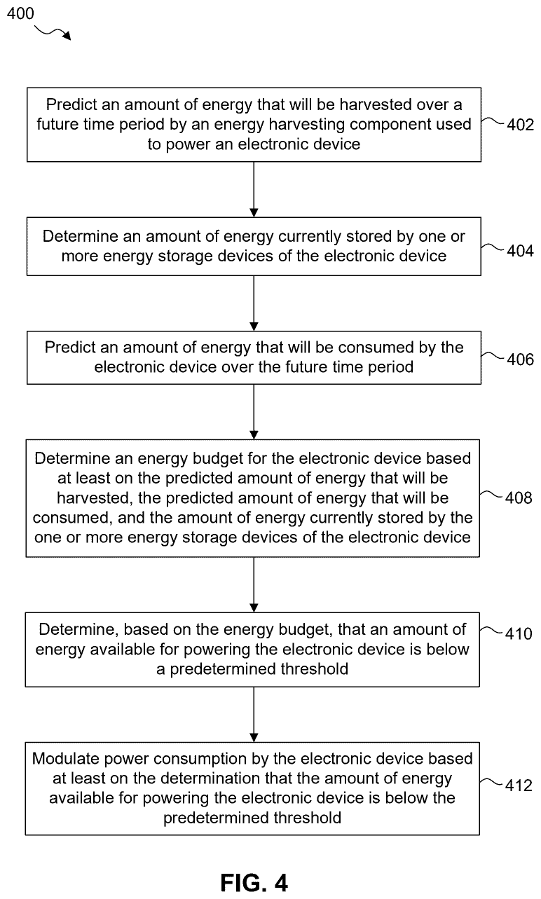

FIG. 4 illustrates a flow diagram of a method 400 for modulating power consumption of an electronic device powered, at least in part, by harvested energy, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to components of power consumption manager 138 of FIGS. 1 and 3. However, method 400 is not limited to that example embodiment.

In 402, energy harvesting prediction module 302 predicts an amount of energy that will be harvested over a future time period by energy harvesting component 134 used to power remote control 110. As previously described, energy harvesting prediction module 302 may execute energy harvesting prediction model 304 to generate the energy harvesting prediction.

In 404, state of charge determination module 310 determines an amount of energy currently stored by one or more energy storage devices (e.g., energy storage device 136) of remote control 110.

In 406, energy consumption prediction module 306 predicts an amount of energy that will be consumed by remote control 110 over the future time period. As previously described, energy consumption prediction module 306 may execute energy consumption prediction model 308 to generate the energy consumption prediction.

In 408, energy budget determination module 312 determines an energy budget for remote control 110 based at least on the predicted amount of energy that will be harvested (obtained from energy harvesting prediction module 302), the predicted amount of energy that will be consumed (obtained from energy consumption prediction module 306), and the amount of energy currently stored by the one or more energy storage devices of the electronic device (obtained from state of charge determination module 310).

In 410, energy budget management module 314 determines, based on the energy budget (obtained from energy budget determination module 312), that an amount of energy available for powering remote control is below a predetermined threshold. For example, energy budget management module 314 may determine, based on the energy budget, that at some future point in time the energy available for powering remote control 110 will drop below a threshold level required to maintain a current mode or level of operation of remote control 110 or that at some future point in time no energy will be available for powering remote control 110.

In 412, energy budget management module 314 modulates power consumption by remote control 110 based on the determination that the amount of energy available for powering remote control 110 is below the predetermined threshold. For example, energy budget management module 314 may modulate power consumption by remote control 110 by switching remote control 110 from operating in a first power consumption mode to operating in a second power consumption mode, wherein operating in the second power consumption mode consumes less power than operating in the first power consumption mode. As further examples, energy budget management module 314 may modulate power consumption by remote control 110 by performing one or more of: disabling a feature of the electronic device, reducing a quality of a service provided by the electronic device, increasing a delay between operations performed by the electronic device, or reducing one or more of a frequency of a processing circuit of the electronic device or a voltage of the processing circuit of the electronic device.

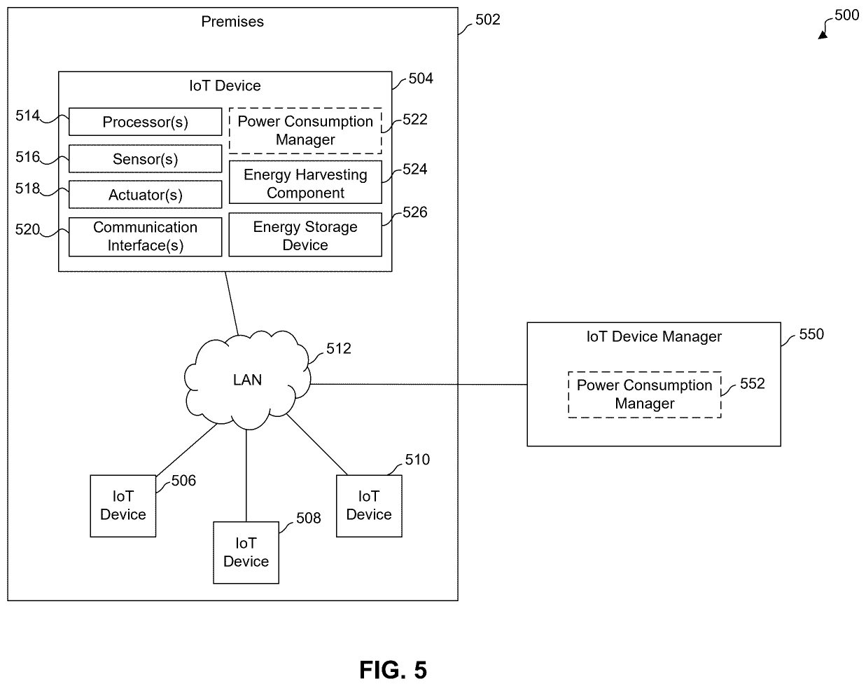

Although the preceding description refers to modulating power consumption by a remote control powered at least in part by an energy harvesting component, the above-described techniques can be applied to any electronic device that is powered at least in part by an energy harvesting component. By way of example, FIG. 5 illustrates a block diagram of a system 500 of Internet of Things (IoT) devices in which at least one IoT device in the system is powered by at least in part by an energy harvesting component and in which the above-described technique may be utilized to modulate power consumption by the at least one IoT device.

In particular, as shown in FIG. 5, system 500 includes a premises 502 in which a plurality of IoT devices 504, 506, 508 and 510 are present. Premises 502 may comprise, for example and without limitation, a house, a property, an office, a building, a factory, a warehouse, a bar, a restaurant, a movie theater, a stadium, an auditorium, a car, a bus, a boat, or any other structure, location or space in which IoT devices may be present. Although only four IoT devices are shown as being present in premises 502 for the sake of illustration, it should be understood that premises 502 may include any number of IoT devices, including tens, hundreds or even thousands of IoT devices.

As used herein, the term “IoT device” is intended to broadly encompass any device that is capable of engaging in digital communication with another device. For example, a device that can digitally communicate with another device can comprise an IoT device, as that term is used herein, even if such communication does not occur over the Internet.

Each of IoT devices 504, 506, 508 and 510 may comprise a device such as, for example, a smart phone, a laptop computer, a notebook computer, a tablet computer, a netbook, a desktop computer, a video game console, a set-top box, or an OTT streaming media player. Furthermore, each of IoT devices 504, 506, 508 and 510 may comprise a so-called “smart home” device such as, for example, a smart lightbulb, a smart switch, a smart refrigerator, a smart washing machine, a smart dryer, a smart coffeemaker, a smart alarm clock, a smart smoke alarm, a smart carbon monoxide detector, a smart security sensor, a smart doorbell camera, a smart indoor or outdoor camera, a smart door lock, a smart thermostat, a smart plug, a smart television, a smart fan, or a smart speaker. Still further, each of IoT devices 504, 506, 508 and 510 may comprise a wearable device such as a watch, a fitness tracker, a health monitor, a smart pacemaker, or an extended reality headset. However, these are only examples and are not intended to be limiting.

IoT devices 504, 506, 508 and 510 may be communicatively connected to a local area network (LAN) 512 via a suitable wired and/or wireless connection. LAN 512 may be implemented using a hub-and-spoke or star topology. For example, in accordance with such an implementation, each of IoT devices 504, 506, 508 and 510 may be connected to a router via a corresponding Ethernet cable, wireless access point (AP), or IoT device hub. The router may include a modem that enables the router to act as an interface between entities connected to LAN 512 and an external wide area network (WAN), such as the Internet. Alternatively, LAN 512 may be implemented using a mesh network topology. For example, in accordance with such an implementation, each of IoT devices 504, 506, 508, and 510 may be linked directly to the other three IoT devices such that it can communicate directly therewith without a router. LAN 512 may also comprise an acoustic network in which communication is carried out using longitudinal waves in a fluid medium such as air or water. However, these are examples only, and other techniques for implementing LAN 512 may be used.

As further shown in FIG. 5, IoT device 504 may comprise one or more processors 514, one or more sensors 516, one or more actuators 518, one or more communication interfaces 520, an energy harvesting component 524, and an energy storage device 526. Processor(s) 514 may comprise one or more central processing units (CPUs), microcontrollers, microprocessors, signal processors, ASICs (application specific integrated circuits), and/or other physical hardware processor circuits for performing tasks such as program execution, signal coding, data processing, input/output processing, power control, and/or other functions.

Sensor(s) 516 may comprise one or more devices or systems for detecting and responding to (e.g., measuring, recording) objects and events in the physical environment of IoT device 504. By way of example only and without limitation, sensor(s) 516 may include one or more of a camera or other optical sensor, a microphone or other audio sensor, a radar system, a LiDAR system, a Wi-Fi sensing system, a temperature sensor, a humidity sensor, a pressure sensor, a proximity sensor, an accelerometer, a gyroscope, a magnetometer, an infrared sensor, a gas sensor, or a smoke sensor.

Actuator(s) 518 may comprise one or more devices or systems that are operable to effect a change in the physical environment of IoT device 504. By way of example only and without limitation, actuator(s) 504 may comprise a component that connects a device to a power source, disconnects a device from a power source, switches a light on or off, adjusts a brightness or a color of a light, turns an audible alarm on or off, adjusts the volume of an audible alarm, initiates a call to a security service, turns a heating or cooling system on or off, adjusts a target temperature associated with a heating or cooling system, locks or unlocks a door, rings a doorbell, initiates capture of video or audio, changes a channel or configuration of a television, adjusts the volume of an audio output device, or the like.

Communication interface(s) 520 may comprise components suitable for enabling IoT device 504 to wirelessly communicate with other devices via a corresponding wireless protocol. Communication interface(s) 520 may include, for example and without limitation, one or more of: a Wi-Fi interface that enables IoT device 504 to wirelessly communicate with an access point or other remote Wi-Fi-capable device according to one or more of the wireless network protocols based on the IEEE (Institute of Electrical and Electronics Engineers) 802.11 family of standards, a cellular interface that enables IoT device 504 to wirelessly communicate with remote devices via one or more cellular networks, a Bluetooth interface that enables IoT device 504 to engage in short-range wireless communication with other Bluetooth-enabled devices, or a Zigbee interface that enables IoT device 504 to wirelessly communicate with other Zigbee-enabled devices.

Communication interface(s) 520 may additionally or alternatively comprise components suitable for enabling IoT device 504 to communicate over a wired connection with other devices via a corresponding wired protocol, such as a Universal Serial Bus (USB), Serial Peripheral Interface (SPI), Controller Area Network (CAN), Local Interconnect Network (LIN), I2C bus, or Ethernet connection and protocol.

Energy harvesting component 524 may comprise a component that harvests energy from an environment of IoT device 504 for the purposes of powering IoT device 504. Energy harvesting component 524 may comprise, for example, a solar panel comprising one or more photovoltaic cells that convert ambient light in the environment of IoT device 502 into energy. However, this example is not intended to be limiting and energy harvesting component 134 may comprise any component capable of harvesting energy from any energy source in the environment of IoT device 504, wherein the energy source may comprise, for example and without limitation, a light source, an electromagnetic field generator, a kinetic energy source (e.g., wind or ambient vibrations), a thermal energy source (e.g., a temperature gradient), a generator of radio waves, or the like.

Energy harvesting component 524 may be integrated with IoT device (e.g., integrated into a housing of IoT device 504) or may be separate from but connectable to IoT device 504 via a physical interface or connector that is suitable for transferring harvested energy from energy harvesting component 524 to IoT device 504.

Energy storage device 526 may comprise, for example, a non-rechargeable battery, a rechargeable battery, or a supercapacitor that stores energy for use in powering IoT device 504. Energy storage device 526 may be housed internally within IoT device 504. Alternatively, energy storage device 526 may be external to IoT device 504 and connected thereto via a suitable physical interface or connector. Although only a single energy storage device 526 is shown in FIG. 5, it should be understood that IoT device 504 may include multiple energy storage devices.

Example non-rechargeable battery types that may be used to power IoT device 504 include but are not limited to alkaline batteries, lithium batteries, mercury batteries, silver oxide batteries or zinc air batteries. Example re-chargeable battery types that may be used to power IoT device 504 include but are not limited to lithium-ion batteries, nickel-cadmium batteries, nickel metal hydride batteries, and lead acid gel batteries. In a case in which energy storage device 526 comprises a rechargeable battery or supercapacitor, IoT device 504 may be configured to recharge energy storage device 526 using energy provided by energy harvesting component 524.

As further shown in FIG. 5, IoT device 504 may further include a power consumption manager 522. Power consumption manager 522 may comprise a component of IoT device 504 that operates at least in part to periodically or intermittently determine an energy budget for IoT device 504 and, when the energy budget indicates that there is insufficient energy to maintain a certain degree of operation of IoT device 504 for a desired time period, to modulate (e.g., reduce) power consumption by IoT device 504 to prolong the operation thereof. Power consumption manager 522 may be implemented using processing logic that can comprise hardware (e.g., circuitry, dedicated logic, programmable logic, microcode, etc.), software (e.g., instructions executing on a processing device), or a combination thereof.

Power consumption manager 522 may include components similar to those described above in reference to power consumption manager 138 of FIG. 1 and FIG. 3, and such components may operate in similar manner to that described above in reference to power consumption manager 138, including the manner described in reference to flowchart 400 of FIG. 4, to modulate power consumption by IoT device 504. That is to say, power consumption manager 522 may predict an amount of energy that will be harvested over a future time period by energy harvesting component 524 (e.g., using an energy harvesting prediction model), determine an amount of energy currently stored by energy storage device 526, predict an amount of energy that will be consumed by IoT device 504 over the future time period (e.g., using an energy consumption prediction model), determine an energy budget for IoT device 504 based at least on the predicted amount of energy that will be harvested, the predicted amount of energy that will be consumed, and the amount of energy currently stored by energy storage device 526, determine, based on the energy budget, that an amount of energy available for powering IoT device 504 is below a predetermined threshold, and reduce power consumption by IoT device 504 based at least on the determination that the amount of energy available for powering IoT device 504 is below the predetermined threshold.

To reduce power consumption by IoT device 504, power consumption manager 522 may disable a particular feature of IoT device, reduce a quality of a service provided by IoT device 504, increase a delay between operations performed by IoT device 504, or reduce one or more of a frequency of a processing circuit (e.g., a CPU, microprocessor, or system-on-chip (SOC)) of IoT device 504 or a voltage of the processing circuit of IoT device 504.

In certain implementations, IoT device 504 may be capable of operating in different power consumption modes. For example, IoT device 504 may be capable of operating in at least a first power consumption mode and a second power consumption mode, wherein operating in the second power consumption mode consumes less power than operating in the first power consumption mode. In accordance with such implementations, power consumption manager 522 may reduce power consumption by IoT device 504 by switching IoT device 504 from operating in the first power consumption mode to operating in the second power consumption mode.

Some non-limiting examples of methods by which power consumption manager 522 may reduce power consumption by IoT device 504 include: temporarily disabling automatic software updates, temporarily disabling a “wake on sound” feature of IoT device 504, reducing a frequency with which IoT device 504 wakes from a low-power state to perform an operation, reducing a power of an RF signal transmitted by IoT device 504, or reducing a transmission data rate of IoT device 504. In an implementation in which IoT device 504 is a smart camera, power consumption manager 522 may reduce power consumption by IoT device 504, for example, by reducing a resolution of the camera, reducing a duration and/or frame rate of recordings captured in response to an event, taking a picture instead of capturing video, or narrowing a set of conditions and/or raising thresholds that will trigger a recording.

Power consumption manager 522 may also determine, based on the energy budget, that an amount of energy available for powering IoT device 504 is above a predetermined threshold, and increase power consumption by IoT device 504 based at least on the determination that the amount of energy available for powering IoT device 504 is above the predetermined threshold.

Each of IoT devices 506, 508 and 510 may include similar components to those shown with respect to IoT device 504. Thus, for example, each of IoT device 506, 508 and 510 may include one or more processors, one or more sensors, one or more actuators, one or more communication interfaces, an energy harvesting component and an energy storage device. Likewise, each of IoT devices 506, 508 and 510 may include a power consumption manager that operates at least in part to periodically or intermittently determine an energy budget for the IoT device and, based on the energy budget, either reduce or increase power consumption by the IoT device.

In an alternate implementation, IoT device 504 may not include power consumption manager 522. Instead, as also shown in FIG. 5, an IoT device manager 550 that is external to IoT device 504 and connected thereto via LAN 512 may include a power consumption manager 552 that operates to perform power consumption management on behalf of IoT device 504. For example, power consumption manager 552 may collect information from IoT device 504 necessary to generate an energy budget for IoT device 504 (e.g., state of charge information, information used as inputs to an energy harvesting prediction model and/or an energy consumption prediction model, and/or information used to train such models) and then provide commands to IoT device 504 for modulating power consumption thereby if power consumption manager 552 determines that such modulation is needed. In a still further implementation, power consumption management features may be distributed between power consumption manager 522 on IoT device 504 and power consumption manager 552 on IoT device manager 550. As one example of this, power consumption manager 522 on IoT device 504 may place a call to power consumption manager 552 (e.g., via LAN 512) to obtain the energy harvesting prediction or the energy consumption prediction. However, this is only an example, and a variety of other distributed processing configurations are possible.

Power consumption manager 552 of IoT device manager 550 may likewise perform power consumption management on behalf of any of IoT devices 506, 508 and 510 that are powered by at least one energy harvesting component.

Power consumption manager 552 may be implemented as processing logic that can comprise hardware (e.g., circuitry, dedicated logic, programmable logic, microcode, etc.), software (e.g., instructions executing on a processing device), or a combination thereof. IoT device manager 550 may be implemented by a device (e.g., a server) that is remote from premises 502 but communicatively connected thereto (e.g., communicatively connected to LAN 512) via one or more networks. Alternatively, IoT device manager 550 may be implemented by a device within premises 502.

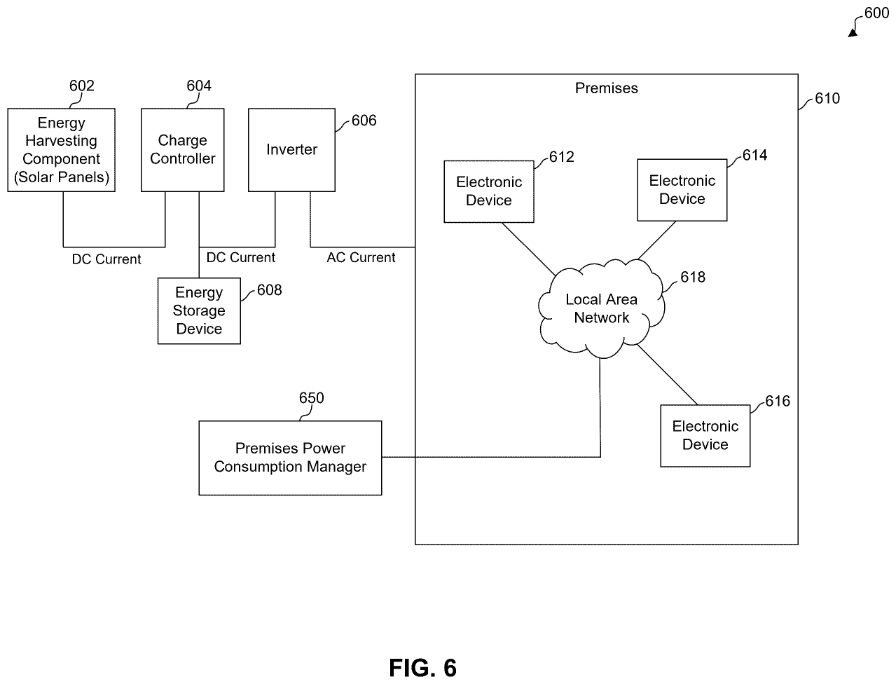

FIG. 6 illustrates a block diagram of a system in which a plurality of electronic devices in a premises are powered by the same energy harvesting component and in which a modified version of the above-described techniques may be utilized to modulate power consumption by one or more of the electronic devices.

In particular, as shown in FIG. 6, system 600 includes a premises 610 in which a plurality of electronic devices 612, 614 and 616 are present. Premises 610 may comprise, for example and without limitation, a home, an office, a building, a factory, a warehouse, a bar, a restaurant, a movie theater, a stadium, an auditorium, a car, a bus, a boat, or any other structure, location or space in which electronic devices may be present. Although only three electronic devices are shown as being present in premises 610 for the sake of illustration, it should be understood that premises 610 may include any number of electronic devices. Each electronic device may comprise, for example, a consumer electronic device, a computing device, an appliance (e.g., air conditioner, refrigerator, dishwasher, oven, stove, washing machine, clothes dryer, hot water heater, furnace), office equipment, an IoT device, or any other electronic device useable within a premises.

In system 600, an energy harvesting component 602, which in this case comprises a set of solar panels, is configured to harvest energy from sunlight that is incident thereon. The solar panels may generate energy in the form of a DC current. Such DC current may be passed to an inverter 606. Inverter 606 may convert the DC current into AC current that can then be used to power electronic devices 612, 614, 616 via an electrical system of premises 610. The DC current may also be used to charge an energy storage device 608 (e.g., solar battery) that can be used to power electronic devices 612, 614 and 616 when energy harvesting component 602 is incapable of harvesting energy. A charge controller 604 may optionally be present to regulate the DC current produced by energy harvesting component 602 to protect energy storage device 608 from electrical surges. Although only a single energy storage device 608 is shown in FIG. 6, it will be understood that system 600 may include a bank of energy storage devices for storing energy harvested by energy harvesting component 602.

Note that in an alternate implementation, energy harvesting component 602 may produce an AC current that may be used to directly power electronic devices 612, 614, 616, in which case charge controller 604 and inverter 606 may not be present.

As further shown in FIG. 6, system 600 includes a premises power consumption manager 650. Premises power consumption manager 650 may be implemented using processing logic that can comprise hardware (e.g., circuitry, dedicated logic, programmable logic, microcode, etc.), software (e.g., instructions executing on a processing device), or a combination thereof. Premises power consumption manager 650 may operate at least in part to periodically or intermittently determine an energy budget for premises 610 and, when the energy budget indicates that there is insufficient energy to maintain a certain degree of operation of electronic devices 612, 614 and 616 for a desired time period, to modulate (e.g., reduce) power consumption by one or more of electronic devices 612, 614 and 616 to prolong the operation of some or all of those electronic devices.

Premises power consumption manager 650 may include components similar to those described above in reference to power consumption manager 138 of FIG. 1 and FIG. 3. However, such components may operate in a slightly different manner to manage the power consumption of electronic devices 612, 614, and 616. For example, in accordance with the implementation shown in FIG. 6, premises power consumption manager 650 may predict an amount of energy that will be harvested over a future time period by energy harvesting component 602, determine an amount of energy currently stored by energy storage device 608, predict an amount of energy that will be consumed by electronic devices 612, 614 and 616 over the future time period, determine an energy budget for premises 610 based at least on the predicted amount of energy that will be harvested, the predicted amount of energy that will be consumed, and the amount of energy currently stored by energy storage device 608, determine, based on the energy budget, that an amount of energy available for powering electronic devices 612, 614 and 616 is below a predetermined threshold, and reduce power consumption by selected ones of electronic devices 612, 614 and 616 based at least on the determination that the amount of energy available for powering electronic devices 612, 614 and 616 is below the predetermined threshold.

Premises power consumption manager 650 may also determine, based on the energy budget, that an amount of energy available for powering electronic devices 612, 614 and 616 is above a predetermined threshold, and increase power consumption by selected ones of electronic devices 612, 614 and 616 based at least on the determination that the amount of energy available for powering electronic devices 612, 614 and 616 is above the predetermined threshold.

To control the power consumption of each of electronic devices 612, 614 and 616, premises power consumption manager 650 may be connected thereto via a local area network (LAN) 618. LAN 618 may be a wired (e.g., Ethernet, home power line) or wireless (e.g., WiFi, mesh) network. Using LAN 618, premises power consumption manager 650 can send power modulation commands to each of electronic devices 612, 614 and 616. For example, premises power consumption manager 650 may selectively command one of electronic devices 612, 614 or 616 to power down or power on. As another example, premises power consumption manager 650 may selectively command one of electronic devices 612, 614 or 616 to switch from operating in a first power consumption mode to operating in a second power consumption mode, wherein the operating in the second power consumption mode consumes less power than operating in the first power consumption mode, or vice versa. As yet another example, premises power consumption manager 650 may selectively command one of electronic devices 612, 614 or 616 to disable or enable a feature of the electronic device, decrease or increase a quality of a service performed by the electronic device, increase or decrease a delay between operations performed by the electronic device, or increase or decrease one or more of a frequency of a processing circuit (e.g., a CPU, microprocessor, or system-on-chip (SOC)) of the electronic device or a voltage of the processing circuit of the electronic device.

In certain implementations, premises power consumption manager 650 may be configured to learn over time which electronic devices a user tends to use and which electronic devices a user tends not to use. Then, based on such information, premises power consumption manager 650 can prioritize powering down or reducing power consumption by an electronic device that the user tends not to use before powering down or reducing power consumption by electronic devices that the user tends to use.

In a further implementation, premises power consumption manager 650 may be configured to power down or reduce power consumption by electronic devices for which some redundancy exists before powering down or reducing power consumption by electronic devices for which no redundancy exists. For example, if premises 610 includes multiple cameras that share an overlapping field of view, then premises power consumption manager 650 may selectively power off one of the cameras if the remaining cameras provide a substantially similar coverage area. As another example, if premises 610 includes multiple remote controls, digital assistants, televisions, PCs, heating systems, cooling systems, etc., that provide redundant functionality, then premises power consumption manager 650 may selectively power off or reduce power consumption by one electronic device in the set of redundant electronic devices.

In a scenario in which one or more of electronic devices 612, 614 and 616 is incapable of receiving and carrying out power modulation commands from premises power consumption manager 650, such commands may instead be received and carried out, for example, by smart plugs, smart switches, or other smart devices that are present in premises 610 and capable of controlling the flow of power to the relevant electronic device. Still other configurations are possible.

Although a single centralized premises power consumption manager 650 is shown in FIG. 6, in an alternate implementation, each of electronic device 612, electronic device 614 and electronic device 616 may include embedded power consumption management logic. In accordance with such an alternate implementation, the electronic devices may operate collaboratively to generate a set of power consumption management decisions. For example, a distributed algorithm for making power consumption management decisions may be executed jointly be the electronic devices and an election algorithm may be used to choose one of the electronic devices as the coordinator. Still other distributed processing configurations are possible.

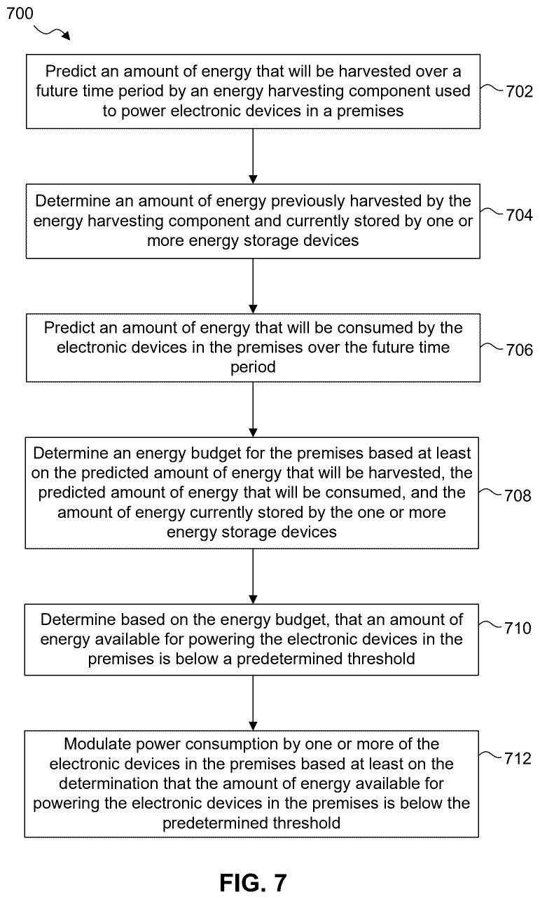

FIG. 7 illustrates a flow diagram of a method 700 for modulating power consumption of one or more electronic devices powered, at least in part, by the same energy harvesting component, according to some embodiments. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to FIG. 6. However, method 700 is not limited to that example embodiment.

In 702, premises power consumption manager 650 predicts an amount of energy that will be harvested over a future time period by energy harvesting component 602 used to power electronic devices 612, 614 and 616 in premises 610. Premises power consumption manager 650 may execute an energy harvesting prediction model to generate the energy harvesting prediction.

In 704, premises power consumption manager 650 determines an amount of energy currently stored by one or more energy storage devices (e.g., energy storage device 608) of system 600.

In 706, premises power consumption manager 650 predicts an amount of energy that will be consumed by electronic devices 612, 614 and 616 in premises 610 over the future time period. Premises power consumption manager 650 may execute an energy consumption prediction model to generate the energy consumption prediction.

In 708, premises power consumption manager 650 determines an energy budget for premises 610 based at least on the predicted amount of energy that will be harvested (from 702), the predicted amount of energy that will be consumed (from 706), and the amount of energy currently stored by the one or more energy storage devices (from 704).

In 710, premises power consumption manager 650 determines, based on the energy budget (from 708), that an amount of energy available for powering electronic devices 612, 614 and 616 in premises 610 is below a predetermined threshold. For example, premises power consumption manager 650 may determine, based on the energy budget, that at some future point in time the energy available for powering electronic devices 612, 614 and 616 in premises 610 will drop below a threshold level required to maintain a current mode or level of operation of electronic devices 612, 614 and 616 or that at some future point in time no energy will be available for powering electronic devices 612, 614 and 616.

In 712, premises power consumption manager 650 modulates power consumption by one or more of electronic devices 612, 614 and 616 in premises 610 based on the determination that the amount of energy available for powering electronic devices 612, 614 and 616 in premises 610 is below the predetermined threshold. For example, premises power consumption manager 650 may modulate power consumption by electronic devices 612, 614 and 616 by causing one or more of those devices to power off. As another example, premises power consumption manager 650 may modulate power consumption by electronic devices 612, 614 and 616 by switching one or more of those electronic devices from operating in a first power consumption mode to operating in a second power consumption mode, wherein operating in the second power consumption mode consumes less power than operating in the first power consumption mode. As further examples, premises power consumption manager 650 may modulate power consumption by electronic devices 612, 614 and 616 by performing one or more of: disabling a feature of one or more of the electronic devices, reducing a quality of a service provided by one or more of the electronic devices, increasing a delay between operations performed by one or more of the electronic devices, or reducing one or more of a frequency of a processing circuit of one or more of the electronic devices or a voltage of a processing circuit of one or more of the electronic devices.

### Example Computer System

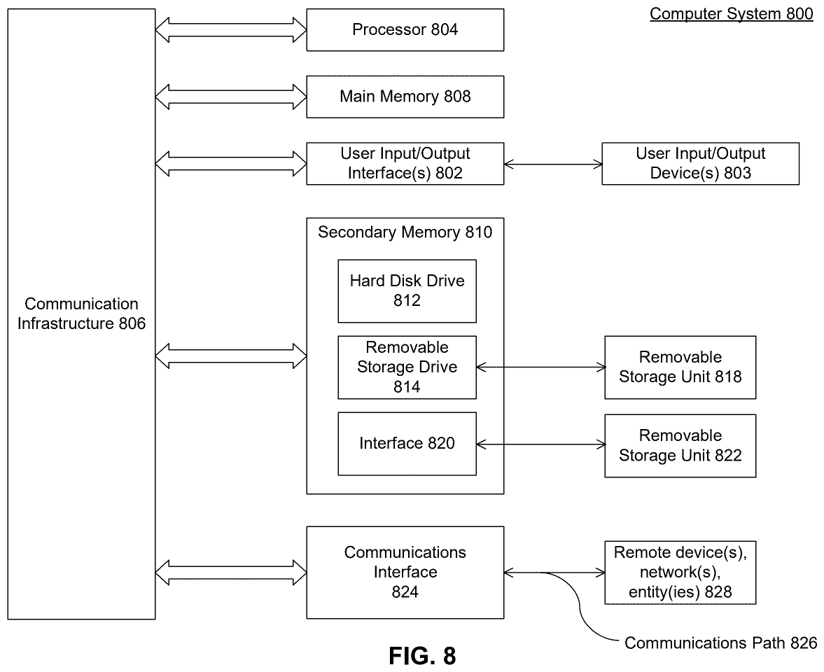

Various embodiments may be implemented, for example, using one or more well-known computer systems, such as computer system 800 shown in FIG. 8. For example, one or more of media device(s) 106, remote control 110, content server(s) 120, system server(s) 126, power consumption manager 138, IoT device 504, IoT device 506, IoT device 508, IoT device 510, IoT device manager 550, power consumption manager 552, electronic device 612, electronic device 614, electronic device 616, or premises power consumption manager 650 may be implemented using computer system 800. Furthermore, one or more features of method 400 or method 700 may be implemented using computer system 800. Alternatively, one or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800 or processor(s) 804), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
executing, by at least one computer processor, a model that predicts an amount of energy that will be harvested over a future time period by an energy harvesting component used to power an electronic device;
determining an energy budget for the electronic device based at least on the predicted amount of energy that will be harvested;
determining that the energy budget is below a predetermined threshold; and
modulating power consumption by the electronic device based at least on the determination that the energy budget is below the predetermined threshold.

2. The computer-implemented method of claim 1, wherein the energy harvesting component comprises one or more photovoltaic cells.

3. The computer-implemented method of claim 1, wherein the energy harvesting component comprises an inductive charging component.

4. The computer-implemented method of claim 1, wherein the electronic device is one of:
a remote control device; or
an Internet of Things (IoT) device.

5. The computer-implemented method of claim 1, wherein executing the model comprises executing a machine learning model.

6. The computer-implemented method of claim 1, wherein determining the energy budget for the electronic device based at least on the predicted amount of energy that will be harvested comprises:
determining the energy budget for the electronic device based at least on the predicted amount of energy that will be harvested and an amount of energy currently stored by one or more energy storage devices of the electronic device.

7. The computer-implemented method of claim 6, further comprising:
predicting an amount of energy that will be consumed by the electronic device over the future time period;
wherein determining the energy budget for the electronic device based at least on the predicted amount of energy that will be harvested and the amount of energy currently stored by the one or more energy storage devices of the electronic device comprises:
determining the energy budget for the electronic device based at least on the predicted amount of energy that will be harvested, the predicted amount of energy that will be consumed, and the amount of energy currently stored by the one or more energy storage devices of the electronic device.

8. The computer-implemented method of claim 1, wherein modulating the power consumption by the electronic device comprises:
switching the electronic device from operating in a first power consumption mode to operating in a second power consumption mode, wherein operating in the second power consumption mode consumes less power than operating in the first power consumption mode.

9. The computer-implemented method of claim 1, wherein modulating the power consumption by the electronic device comprises one or more of:
disabling a feature of the electronic device;
reducing a quality of a service provided by the electronic device;
increasing a delay between operations performed by the electronic device; or
reducing one or more of a frequency of a processing circuit of the electronic device or a voltage of the processing circuit of the electronic device.

10. A system, comprising:
one or more memories; and
at least one processor each coupled to at least one of the memories and configured to perform operations comprising:
executing a model that predicts an amount of energy that will be harvested over a future time period by an energy harvesting component used to power an electronic device;
determining an energy budget for the electronic device based at least on the predicted amount of energy that will be harvested;
determining that the energy budget is below a predetermined threshold; and
modulating power consumption by the electronic device based at least on the determination that the energy budget is below the predetermined threshold.

11. The system of claim 10, wherein the energy harvesting component comprises one or more photovoltaic cells.

12. The system of claim 10, wherein the energy harvesting component comprises an inductive charging component.

13. The system of claim 10, wherein the electronic device is one of:
a remote control device; or
an Internet of Things (IoT) device.

14. The system of claim 10, wherein executing the model comprises executing a machine learning model.

15. The system of claim 10, wherein determining the energy budget for the electronic device based at least on the predicted amount of energy that will be harvested comprises:
determining the energy budget for the electronic device based at least on the predicted amount of energy that will be harvested and an amount of energy currently stored by one or more energy storage devices of the electronic device.

16. The system of claim 10, wherein the operations further comprise:
predicting an amount of energy that will be consumed by the electronic device over the future time period;
wherein determining the energy budget for the electronic device based at least on the predicted amount of energy that will be harvested and the amount of energy currently stored by the one or more energy storage devices of the electronic device comprises:
determining the energy budget for the electronic device based at least on the predicted amount of energy that will be harvested, the predicted amount of energy that will be consumed, and the amount of energy currently stored by the one or more energy storage devices of the electronic device.

17. The system of claim 10, wherein modulating the power consumption by the electronic device comprises:
switching the electronic device from operating in a first power consumption mode to operating in a second power consumption mode, wherein operating in the second power consumption mode consumes less power than operating in the first power consumption mode.

18. The system of claim 10, wherein modulating the power consumption by the electronic device comprises one or more of:
disabling a feature of the electronic device;
reducing a quality of a service provided by the electronic device;
increasing a delay between operations performed by the electronic device; or
reducing one or more of a frequency of a processing circuit of the electronic device or a voltage of the processing circuit of the electronic device.

19. A non-transitory computer-readable medium having instructions stored thereon that, when executed by at least one computing device, causes the at least one computing device to perform operations comprising:
executing a model that predicts an amount of energy that will be harvested over a future time period by an energy harvesting component used to power an electronic device;
determining an energy budget for the electronic device based at least on the predicted amount of energy that will be harvested;
determining that the energy budget is below a predetermined threshold; and
modulating power consumption by the electronic device based at least on the determination that the energy budget is below the predetermined threshold.

20. The non-transitory computer-readable medium of claim 19, wherein determining the energy budget for the electronic device based at least on the predicted amount of energy that will be harvested comprises:
determining the energy budget for the electronic device based at least on the predicted amount of energy that will be harvested and an amount of energy currently stored by one or more energy storage devices of the electronic device.
